(19) United States
(12) Patent Application Publication
(10) Pub. No.: US 2025/0368317 A1
(43) Pub. Date: Dec. 4, 2025

(54) SYSTEMS, METHODS, AND DEVICES FOR OPERATION OF A VEHICLE

(71) Applicant: Supernal, LLC, Washington, DC (US)

(72) Inventors: Awais RAZA, Redondo Beach, CA (US); Benjamin Douglas NARAVAGE, Escondido, CA (US); Martin Wesley SHUBERT, JR., Tall Timbers, MD (US); Sean Patrick PITONIAK, Costa Mesa, CA (US); Jonathan TOTH, Fort Worth, TX (US); David GUERRERO, Eureka, CA (US)

(73) Assignee: Supernal, LLC, Washington, DC (US)

(21) Appl. No.: 18/872,192

(22) PCT Filed: Aug. 4, 2023
(86) PCT No.: PCT/US2023/071723

§ 371 Date: Dec. 5, 2024

Related U.S. Application Data
(60) Provisional application No. 63/370,601, filed on Aug. 5, 2022.

(51) Int. Cl. B64C 13/04; B64C 13/24; B64D 31/04

(52) U.S. Cl. CPC B64C 13/042; B64C 13/24; B64D 31/04

(57) ABSTRACT

The present disclosure generally provides for a control system for controlling an aircraft. The control system may comprise an input device configured to be manipulated by a user, the input device having a first orientation and a second orientation, at least one rotor, at least one control surface; and a controller coupled with the input device, the at least one rotor, and the at least one control surface. The controller may be configured to determine a speed profile of the aircraft, determine the orientation of the input device, send a command to the at least one rotor and/or the at least one control surface based in part on the speed profile and the orientation of the input device; and adjust the at least one rotor and/or the at least one control surface.

### CROSS-REFERENCE TO RELATED APPLICATIONS

This application claims the benefit of priority to International Application No. PCT/US2023/071723, filed Aug. 4, 2023, which claims the benefit of priority to U.S. Provisional Patent Application No. 63/370,601, filed Aug. 5, 2022, the entireties of which are incorporated herein by reference.

### TECHNICAL FIELD

Embodiments of this disclosure are directed to vehicle control, specifically, systems and methods for controlling position and orientation of an aircraft.

### BACKGROUND OF THE INVENTION

The changes between high-speed and low-speed flight of hybrid vertical takeoff and landing vehicles (VTOL) result in a notable change in how the forces are imparted from the rotors and control surfaces to the vehicle. For example, the vehicle operator may need to make more precise movements at low-speeds and may need to maintain speed, orientation, and/or direction at higher speeds.

Some types of VTOL craft, such as drones and helicopters, may efficiently create vertical lift. However, these types of VTOL craft are known to have poor horizontal thrust capability and are not suitably scalable to move persons or goods over longer distances efficiently. With regards to VTOL aircraft having multiple rotors for creating vertical lift, such VTOL aircraft can also potentially become unbalanced if one or more of the rotors becomes inactive or disabled.

There is a need for vehicle controls that simplify the transition between low-speed and high-speed flight. Additionally, there is a need for vehicle controls that improve roll, pitch, and yaw control which reduce pilot workload and ensure safe and viable operations at all flight speeds, attitudes, and configurations.

### SUMMARY OF THE DISCLOSURE

The present disclosure provides a vehicle control system and related methods that simplify the transition between low-speed and high-speed control of the aircraft. Additionally, the vehicle control system improves the transition between different control strategies to reduce pilot workload and ensure safe and viable operations at all flight speeds, attitudes, and configurations.

The present disclosure may describe an aircraft control system for controlling an aircraft at a first speed and a second speed. The aircraft control system may include: an input device configured to be manipulated by a user, the input device may have a first orientation and a second orientation; at least one rotor operably coupled to a body of the aircraft; at least one control surface operably coupled to the body of the aircraft, and a controller coupled with the input device, the at least one rotor, and the at least one control surface. The controller may be configured to: determine a speed profile of the aircraft based on a speed which the aircraft is traveling; determine whether the input device is in the first orientation or the second orientation; send a command to one or both of the at least one rotor and the at least one control surface based at least in part on the speed profile and the position of the input device; and adjust at least one of the at least one rotor or the at least one control surface.

Various aspects of the system may include: wherein, when the aircraft is in the speed profile corresponding to a first speed and the input device is in the first orientation, a first command may be sent to the at least one rotor and/or the at least one control surface; wherein, when the aircraft is in the speed profile corresponding to a second speed and the input device is in the first orientation, a second command may be sent to the at least one rotor and/or the at least one control surface; wherein, when the aircraft is in the speed profile corresponding to the first speed and the input device is in the second orientation, a third command may be sent to the at least one rotor and/or the at least one control surface; wherein, when the aircraft is in the speed profile corresponding to the second speed and the input device is in the second orientation, a fourth command may be sent to the at least one rotor and/or the at least one control surface; wherein each of the first command, the second command, the third command, and the fourth command may be different from each other; wherein the first command and the second command may be the same, and the third command and the fourth command may be different from the first command and the second command; wherein the third command and the fourth command may be different from one another; wherein the aircraft control system may further include a speed profile corresponding to a third speed, and wherein, when the input device is in the first orientation and the controller has determined that the aircraft is in the speed profile corresponding to the third speed, a fifth command may be sent to the at least one rotor and/or at least one control surface; wherein the input device may be two input devices; wherein the controller may further be configured to: determine the position of the first input device; determine the position of the second input device; and may send a command to the at least one rotor and/or the at least one control surface based on the speed profile and the orientation of the first input device and the orientation of the second input device; wherein the two input devices may be a first inceptor and a second inceptor; wherein the second orientation of the input device may be different from the first orientation of the input device.

The present disclosure may further relate to an aircraft control system, including: a first input device and a second input device. Each of the first input device and the second input device may be configured to be manipulated by a user. The first input device and the second input device may each have a first orientation, and a second orientation different from the first orientation. The aircraft control system may include at least one rotor operatively connected with a body of the aircraft, and at least one control surface operatively connected to the body of the aircraft. The aircraft control system may include a controller electrically coupled with the first input device, the second input device, the at least one rotor, and the at least one control surface. The controller may be configured to: determine a speed profile of the aircraft based on a speed of the aircraft; determine an orientation of the first input device; determine an orientation of the second input device; send a command to the at least one rotor and/or the at least one control surface based on the speed profile and the orientation of the first input device and the orientation of the second input device; and adjust the at least one rotor and/or the at least one control surface.

Various aspects of the system may include one or more of the following: wherein the first input device may be a first inceptor and the second input device may be a second inceptor; wherein, when the aircraft is in a first speed profile, the first input device may be in the first orientation and the second input device may be in the first orientation, a first command may be sent to the at least one rotor and/or the at least one control surface; wherein the first command may be a compound movement which may cause the at least one rotor and/or the at least one control surface to change a position and an orientation of the aircraft; wherein, when the aircraft is in the first speed profile, the first input device may be in the first orientation and the second input device may be in the second orientation, a second command may be sent to the at least one rotor and/or the at least one control surface; wherein, when the air craft is in a second speed profile, the first input device may be in the first orientation, and the second input device may be in the second orientation, a third command may be sent to the at least one rotor and/or the at least one control surface; wherein the aircraft control system may further include a third speed profile; and wherein, when the input device is in the first orientation and the controller has determined that the aircraft is in the third speed profile, a fourth command may be sent to the at least one rotor and/or at least one control surface.

### BRIEF DESCRIPTION OF THE FIGURES

The accompanying drawings, which are incorporated in and constitute a part of this specification, illustrate various examples and, together with the description, serve to explain the principles of the disclosed examples and embodiments.

Aspects of the disclosure may be implemented in connection with embodiments illustrated in the attached drawings. These drawings show different aspects of the present disclosure and, where appropriate, reference numerals illustrating like structures, components, materials, and/or elements in different figures are labeled similarly. It is understood that various combinations of the structures, components, and/or elements, other than those specifically shown, are contemplated and are within the scope of the present disclosure.

Moreover, there are many embodiments described and illustrated herein. The present disclosure is neither limited to any single aspect or embodiment thereof, nor is it limited to any combinations and/or permutations of such aspects and/or embodiments. Moreover, each of the aspects of the present disclosure, and/or embodiments thereof, may be employed alone or in combination with one or more of the other aspects of the present disclosure and/or embodiments thereof. For the sake of brevity, certain permutations and combinations are not discussed and/or illustrated separately herein. Notably, an embodiment or implementation described herein as “exemplary” is not to be construed as preferred or advantageous, for example, over other embodiments or implementations; rather, it is intended to reflect or indicate the embodiment(s) is/are “example” embodiment(s).

FIG. 1 illustrates a perspective view of one example of a hybrid vertical takeoff

vehicle, according to the present disclosure.

FIG. 2A illustrates a hybrid vertical takeoff vehicle with axes of movement in a first configuration.

FIG. 2B illustrates a hybrid vertical takeoff vehicle with axes of movement in a second configuration.

FIG. 3 illustrates one example of a cockpit area of a hybrid vertical takeoff vehicle, according to the present disclosure.

FIG. 4 illustrates an inceptor and directions of movement, according to the present disclosure.

FIG. 5 is a schematic view of an example vehicle control system, according to the present disclosure.

FIG. 6 illustrates an example control method of the vehicle control system, according to the present disclosure.

FIG. 7 illustrates an example control diagram based on longitudinal and lateral speed of the hybrid VTOL aircraft, according to the present disclosure.

FIG. 8 illustrates a diagram depicting example commands the vehicle control system may issue in response to inceptor operation, according to the present disclosure.

FIG. 9 illustrates a diagram depicting example commands the vehicle control system may issue in response to inceptor operation, according to the present disclosure.

FIG. 10 illustrates a diagram depicting example commands the vehicle control system may issue in response to inceptor operation, according to the present disclosure.

FIG. 11 illustrates a diagram depicting example commands the vehicle control system may issue in response to inceptor operation, according to the present disclosure.

FIG. 12 illustrates a diagram depicting example commands the vehicle control system may issue in response to inceptor operation, according to the present disclosure.

FIG. 13 illustrates a diagram depicting example commands the vehicle control system may issue in response to inceptor operation, according to the present disclosure.

FIG. 14 illustrates a diagram depicting example commands the vehicle control system may issue in response to inceptor operation, according to the present disclosure.

As used herein, the terms “comprises,” “comprising,” “includes,” “including,” or any other variation thereof, are intended to cover a non-exclusive inclusion, such that a process, method, article, or apparatus that comprises a list of elements does not include only those elements, but may include other elements not expressly listed or inherent to such process, method, article, or apparatus. The term “exemplary” is used in the sense of “example,” rather than “ideal.” In addition, the terms “first,” “second,” and the like, herein do not denote any order, quantity, or importance, but rather are used to distinguish an element or a structure from another. Moreover, the terms “a” and “an” herein do not denote a limitation of quantity, but rather denote the presence of one or more of the referenced items.

Notably, for simplicity and clarity of illustration, certain aspects of the figures depict the general structure and/or manner of construction of the various embodiments. Descriptions and details of well-known features and techniques may be omitted to avoid unnecessarily obscuring other features. Elements in the figures are not necessarily drawn to scale; the dimensions of some features may be exaggerated relative to other elements to improve understanding of the example embodiments. For example, one of ordinary skill in the art appreciates that the side views are not drawn to scale and should not be viewed as representing proportional relationships between different components. The side views are provided to help illustrate the various components of the depicted assembly, and to show their relative positioning to one another.

### DETAILED DESCRIPTION

Reference will now be made in detail to examples of the present disclosure, which are illustrated in the accompanying drawings. Wherever possible, the same reference numbers will be used throughout the drawings to refer to the same or like parts. In the discussion that follows, relative terms such as “about,” “substantially,” “approximately,” etc. are used to indicate a possible variation of a numerical range in a stated numeric value, as will be designated below.

The present disclosure generally provides for systems, methods, and devices of controlling a vertical takeoff and landing (VTOL) aircraft at various speeds, modes, and phases of flights to control position, orientation, direction, and/or speed of the VTOL aircraft. Although the present disclosure makes reference to a VTOL aircraft, those of ordinary skill in the art will readily recognize that reference to an aircraft is exemplary, and that the concepts of the present disclosure may be used in conjunction with any suitable or comparable aircraft, e.g., airplanes, helicopters, aerostats, flight simulators, space crafts, commercial airplanes, or electrical vertical takeoff and landing aircrafts (eVTOL aircrafts). Still further, aspects of the present disclosure may be used in conjunction with any vehicle, including, but not limited to, vehicles designed for operation on land, on water, in the air, in space, or any combination thereof. The above list is not, in any matter, supposed to signify a limited list of what the term “aircraft” defines in terms of structure.

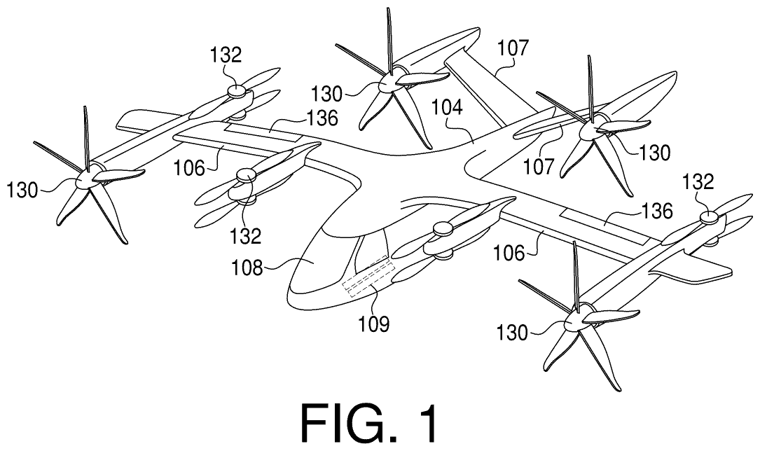

Turning to FIG. 1, a perspective view of an exemplary hybrid VTOL aircraft 102 (herein VTOL aircraft 102), according to one or more embodiments, is provided. VTOL aircraft 102 may function to travel short and long distances to provide transportation to passengers, luggage, cargo, and/or other objects that one of ordinary skill in the art will appreciate. VTOL aircraft 102 may include a fuselage 104, front wings 106, rear wings 107, cockpit 108, tilt rotors 130, rotors 132, and control surfaces 134, e.g., flaps 136. In the example of FIG. 1, VTOL aircraft 102 may be an eVTOL aircraft and include one or more batteries 109 located within fuselage 104.

Fuselage 104 may function as a base or a body of VTOL aircraft 102 and support front wings 106, rear wings 107, tilt rotors 130, rotors 132, and control surfaces 134. Fuselage 104 may include cockpit 108, as well as an interior volume configured to house passengers, cargo, the like, or a combination thereof.

Front wings 106 may be connected with a forward portion of fuselage 104. Rear wings 107 may be connected with an aft portion of fuselage 104. Front wings 106 and rear wings 107 may function to assist VTOL aircraft during flight by providing lift as the aircraft travels through the air. In some examples, front wings 106 and rear wings 107 may function to connect tilt rotors 130 and rotors 132, as well as, control surfaces 134 to the fuselage 104. As will be described below, control surfaces 134 are connected to the front wings 106, rear wings 107, or both to assist in maneuvering.

Control surfaces 134 may be connected with the front wings 106 and/or rear wings 107. In some examples, control surfaces may be connected with fuselage 104. Control surfaces 134 may function to assist with maneuvering VTOL aircraft 102 during flight. Control surfaces 134 may be elevators, rudders, ailerons, ruddervators, flaperons, trim, nacelle, flaps or any other control surfaces known to one of ordinary skill in the art. In FIG. 1, control surfaces 134 are shown in one example as flaps 136. Control surfaces 134 may be configured to assist with moving VTOL aircraft 102 in a plurality of degrees of freedom.

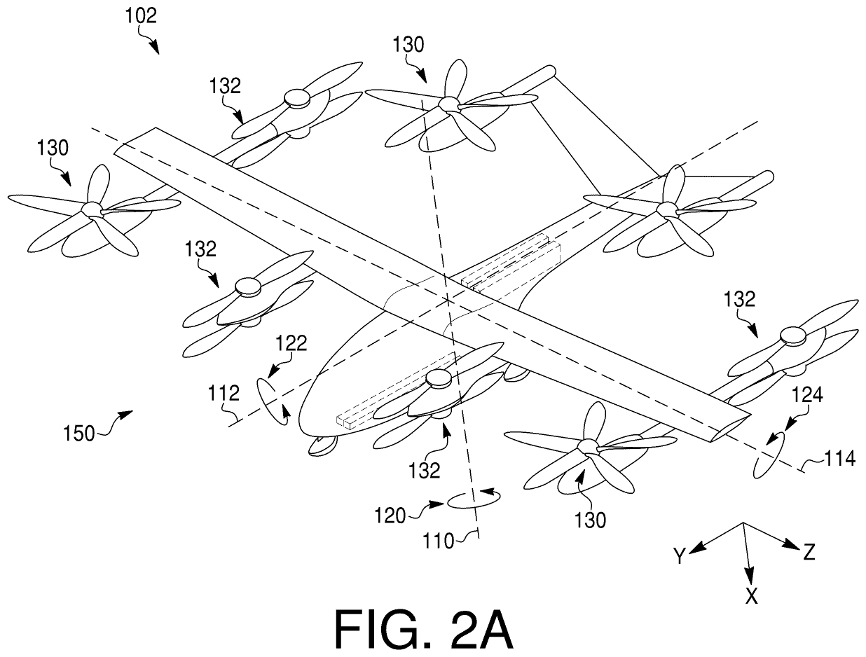

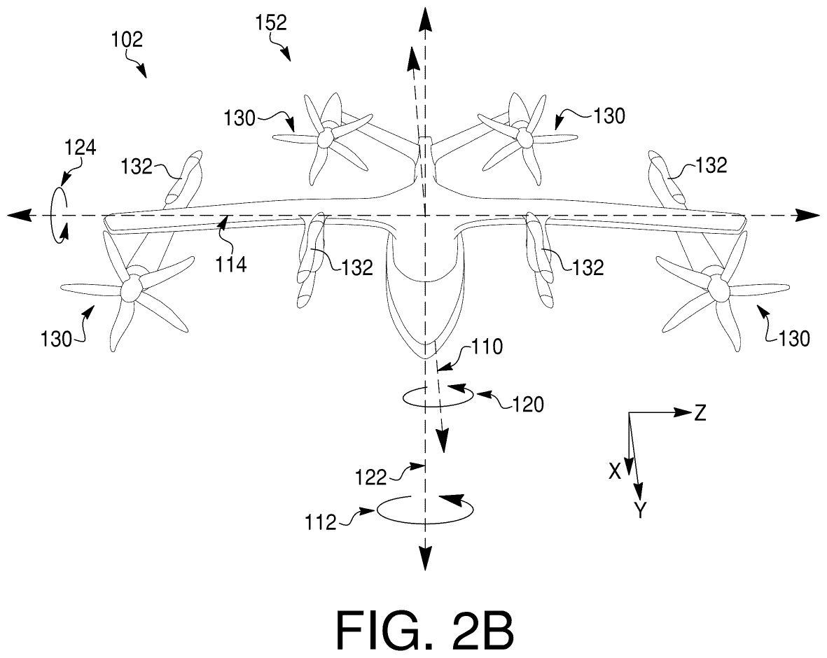

Tilt rotors 130 may be connected with the front wings 106, rear wings 107, or both. In some examples, tilt rotors 130 may be connected with fuselage 104. Tilt rotors 130 may be a propulsion source to move VTOL aircraft 102. Tilt rotors 130 may be connected with one or more motors for rotating the tilt rotors 130 to produce thrust. In some examples, tilt rotors 130 may pivot relative to the front wings 106, rear wings 107, or both to transition between a longitudinal position and a vertical position. In some examples, VTOL aircraft may only have tilt rotors 130 as a propulsion source. In other examples, tilt rotors 130 may be used in combination with other types of propulsion such as rotors 132, jet engines, the like or a combination thereof. Tilt rotors 130 may provide a primary thrust for takeoff and landing in the vertical position, as well as the thrust required to sustain altitude and velocity when in the longitudinal position. In some examples, VTOL aircraft 102 may include two or more tilt rotors 130. In one example, such as shown in FIGS. 1 and 2A-2B, VTOL aircraft 102 includes four tilt rotors 130 with two tilt rotors 130 located on front wings 106 and two tilt rotors 130 located on rear wings 107. It will be appreciated that even numbers of tilt rotors 130 may be provided. Tilt rotors 130 may be configured to assist with moving VTOL aircraft 102 in a plurality of degrees of freedom.

Rotors 132 may be connected with front wings 106, rear wings 107, or both. In some examples, rotors 132 may have a fixed axis of rotation such that rotors 132 are always rotating parallel to vertical axis 110. In some other examples, rotors 132 may be positioned in vertical positions, horizontal positions, or both. Rotors 132 may be a propulsion source to move VTOL aircraft 102. In other examples, rotors 132 may be positioned to rotate parallel to longitudinal axis 112. In other examples, a combination of rotors 132 positioned with their axis of rotation parallel to vertical axis 110 and positioned with their axis of rotation parallel to longitudinal axis 112 may be used. In some other examples, VTOL aircraft 102 may only have rotors 132 as a propulsion source. Rotors 132 may provide thrust to VTOL aircraft 102 during takeoff and landing, and may further provide enhanced maneuverability for VTOL aircraft 102. In some examples, VTOL aircraft 102 may include any number of rotors 132. In one example, such as shown in FIGS. 1 and 2A-2B, VTOL aircraft 102 includes four rotors 132 connected with front wings 106. Rotors 132 may be configured to assist with moving VTOL aircraft 102 in a plurality of degrees of freedom.

Turning to FIGS. 2A and 2B, VTOL aircraft 102 is illustrated in a first configuration and a second configuration, respectively. In some examples, VTOL aircraft 102 may operate in discrete modes between the first configuration and the second configuration, which will be explained further below.

FIG. 2A illustrates VTOL aircraft 102 in one example of the first configuration, a VTOL configuration 150 (also known as a rotorborne configuration). FIG. 2A depicts VTOL aircraft 102 and vertical axis 110, longitudinal axis 112, lateral axis 114, which VTOL aircraft 102 may translate and/or rotate about. In VTOL configuration 150, tilt rotors 130 are shown in a vertical direction, such that the tilt rotors 130 are positioned with their axis of rotation parallel to vertical axis 110 (also referred to as y-axis; yaw axis). in which VTOL vehicle 102 may operate. VTOL aircraft 102 may travel generally up or down vertical axis 110 at various times throughout a flight (e.g., during climbing, descending, takeoff, and/or landing). VTOL aircraft 102 may also rotate about vertical axis 110 as shown by rotation arrow 120 for a yaw movement. VTOL aircraft 102 may also move along longitudinal axis 112 (also known as the x-axis; roll axis) generally backward or forward. VTOL vehicle 102 may rotate (roll) relative to longitudinal axis 112 as shown by rotation arrow 122. VTOL aircraft 102 may travel generally side to side along lateral axis 114 (e.g., translate), as well as rotate about lateral axis 114 to cause a pitch movement, as shown by rotation arrow 124.

Turning now to FIG. 2B, VTOL aircraft 102 is illustrated in the wingborne configuration 152 with each of the tilt rotors 130 arranged with their axis of rotation parallel to longitudinal axis 112. Similar to FIG. 2A, VTOL aircraft 102 is capable of moving along each of vertical axis 110, longitudinal axis 112, and lateral axis 114. In the wingborne configuration 152, VTOL aircraft 102 may travel generally forwards along longitudinal axis 112 and may also roll about longitudinal axis 112 as shown by rotation arrow 122. In wingborne configuration 152, VTOL aircraft 102 may rotate about lateral axis 114 (e.g., pitch up; pitch down). VTOL aircraft 102 may climb up and down along vertical axis 110, as well as also rotate about vertical axis 110 as shown by rotation arrow 120 causing a yaw movement of VTOL aircraft 102.

As illustrated in FIGS. 2A and 2B, VTOL aircraft 102 may be configured to maneuver in a plurality of degrees of freedom. In this example, VTOL aircraft 102 may be configured to move in six degrees of freedom. VTOL aircraft 102 may be configured to translate along each of vertical axis 110, longitudinal axis 112, and lateral axis 114. Similarly, VTOL aircraft 102 may be configured to rotate about each of vertical axis 110, longitudinal axis 112, and lateral axis 114, shown as rotation arrow 120, rotation arrow 122, and rotation arrow 124, respectively.

Each of VTOL configuration 150 and wingborne configuration 152 may cause VTOL aircraft 102 to operate in specific ways. When VTOL aircraft 102 is in VTOL configuration 150, VTOL aircraft may operate at a low-speed. In some examples, a low-speed may refer to VTOL aircraft 102 traveling at a rate of 0 Knots to 30 Knots. However, in some other examples, “low-speed” may be between 0 Knots and 150 Knots or more. For example, tilt rotors 130, along with rotors 132 may be used for vertical thrust (e.g., VTOL configuration 150). In VTOL configuration 150, control surfaces 134, along with a landing gear (not shown) may be extended and/or engaged.

When VTOL aircraft 102 is in wingborne configuration 152, VTOL aircraft may travel at high-speed. High-speed may refer to movement during cruise, cross-country travel, or similar. High-speed may be a relative range between a speed higher than the low-speed range and a maximum speed of the craft. In some non-limiting examples, high-speed may be between 30 knots and 150 Knots. In other non-limiting examples, the high-speed range may be between 30 Knots or less and 450 Knots or more. For example, the tilt rotors 130 may be used for horizontal thrust when in the wingborne configuration 152. In the wingborne configuration 152, one or more of control surfaces 134, landing gear, or the like may be retracted and/or concealed within VTOL aircraft 102.

VTOL aircraft 102 may operate at a transitional speed. The transitional speed may be considered a “medium” speed and correspond to VTOL aircraft 102 transitioning between VTOL configuration 150 and wingborne configuration 152. Put differently, transitional speed may be when the physical configuration of VTOL aircraft 102 changes such that the mechanism for creating forces and moments on the VTOL aircraft 102 changes. Additionally, transitional speed may be a range of speed which the control system of VTOL aircraft 102 may change the types of commands. For example, tilt rotors 130 may be in the process of switching from primarily vertical thrust (e.g., VTOL configuration 150) to primarily horizontal thrust (e.g., wingborne configuration 152). As another example, control surfaces 134 and/or landing gear may be in the process of moving from an extended position to a retracted position or vice versa. Transitional speed may refer to vehicle movement during a transition between a low-speed and a high-speed. Transitional speed may be any speed between low-speed and high-speed operation and/or configuration, explained further below. In some non-limiting examples, the transitional speed may be considered between 20 Knots and 60 Knot. In other non-limiting examples, the transitional speed may be between 10 Knots and 120 Knots or more. A combination of transitions of tilt rotors 130, control surface 134, and/or landing gear(s) are contemplated during the transitional speed. Any other control surfaces 134, such as spoilers, throttle, pitch control of any rotors, rotor speed of rotors, any type of flaps, wing surfaces to resist rotation, rudders, or any other control surfaces as would be known to one of ordinary skill in the art, may be implemented to transition VTOL aircraft 102 from high-speed to low-speed or vice versa.

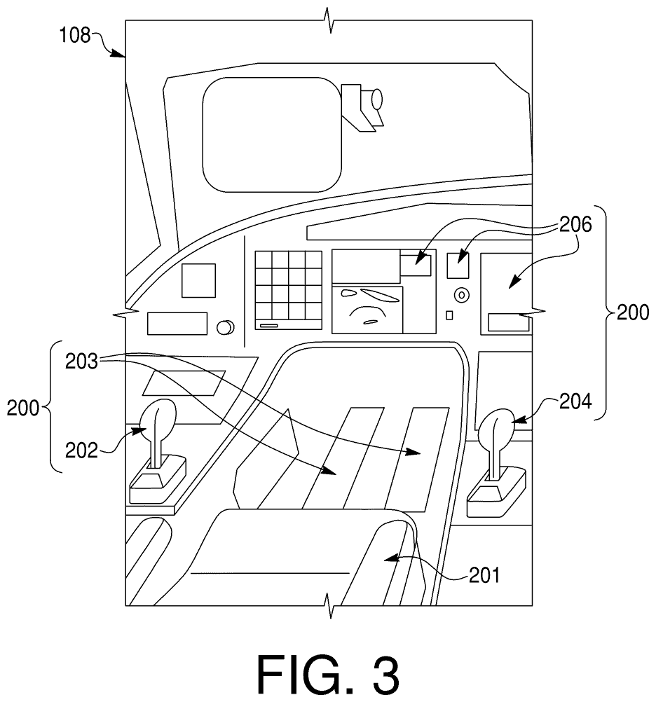

As briefly described above, cockpit 108 may be located at a forward portion of fuselage 104. FIG. 3 illustrates one example of cockpit 108. Cockpit 108 may function as the control center of VTOL aircraft 102, configured with a plurality of input devices 200 for one or more operators to interface with in order to control the aircraft. In some examples, the cockpit 108 may include at least a portion of a vehicle control system 100, which will be described further below.

### Control System

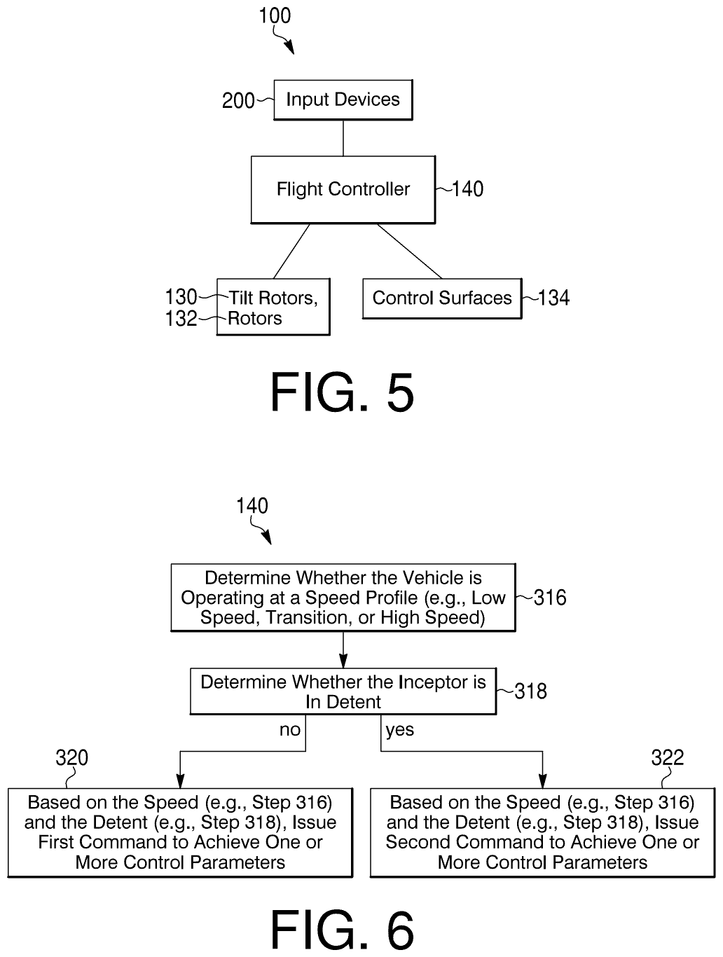

To operate VTOL aircraft 102, VTOL aircraft 102 may include a vehicle control system 100 (FIG. 5) configured to control VTOL aircraft 102 at various speeds, modes, and phases of flights. For example, vehicle control system 100 may provide control of VTOL aircraft 102 during a takeoff (e.g., ascent) or a landing (e.g., descent) phase of flight. While those of ordinary skill in the art may understand that takeoff and landing phases of flight may be at relatively lower speeds of flight, vehicle control system 100 is not limited to providing control during only these phases of flight. Indeed, vehicle control system 100 may also control VTOL aircraft 102 during cruise phases of flight that are conducted at relatively higher speeds when compared to takeoff and landing phases of flight. Still further, vehicle control system 100 may also facilitate control of VTOL aircraft 102 during transitional phases of flight, e.g., phases of flight between relatively lower and relatively higher speeds. The control system 100 may provide safe aircraft control for all normal and degraded system operations.

Vehicle control system 100 may be configured to implement multiple control strategies corresponding to the various phases of flight described above. Control system 100 may be configured to guaranty availability of highly augmented control modes. For example, during a first phase of flight (e.g., a phase of flight at relatively lower speeds), vehicle control system 100 may implement a first control strategy, described further below. Similarly, during a second phase of flight (e.g., a phase of flight at relative higher speeds), vehicle control system 100 may implement a second control strategy, described further below.

Vehicle control system 100 may include flight controller 140, a plurality of input devices 200, and any other suitable components for controlling a direction, position, orientation, and/or speed of VTOL aircraft 102 by adjusting control surfaces 134, tilt rotors 130, and/or rotors 132. Vehicle control system 100 may include controllers, drivers, memory, sensors, hardware, software, and/or any other components for controlling VTOL aircraft 102. Vehicle control system 100 may further include tilt rotors 130, rotors 132, control surfaces 134, and the like in order to control and maneuver VTOL aircraft 102.

Vehicle control system 100 may include flight controller 140. Flight controller 140 may function to receive signals from input devices 200 and process those signals to control various aspects of VTOL aircraft 102. Flight controller 140 may be connected with one or more of tilt rotors 130, rotors 132, and control surfaces 134 to maneuver VTOL aircraft 102. Flight controller 140 may be a fly-by-wire control system that makes up a portion of vehicle control system 100. Flight controller 140 may include one or more processors, drivers, memories, the like or other electronic components to send, receive, and process electronic signals. Flight controller 140 may be connected with input devices 200 to receive commands from an operator of the aircraft and process those signals to send a command to one or more of tilt rotors 130, rotors 132, and control surfaces 134. In some examples, input devices 200, such as various sensors, may be connected with fuselage 104, tilt rotors 130, rotors 132, control surfaces 134 or a combination thereof to send signals to flight controller 140 to indicate a variety of flight characteristics. Some flight characteristics that the various sensors may provide are speed, height, position of tilt rotors 130, position of landing gear, temperature, or any other useful data that one of ordinary skill in the art would appreciate for controlling an aircraft. When flight controller 140 sends command signals to one or more of tilt rotors 130, rotors 132, and control surfaces 134, VTOL aircraft 102 may change or hold direction, position, orientation, and/or speed. In some examples, flight controller 140 may be a mechanical control system. In another example, flight controller 140 may include electrical and mechanical components. In some other examples, first inceptor 202 and second inceptor 204 may be mechanically linked to one or more of control surfaces 134.

As mentioned above, vehicle control system 100 may include one or more of input devices 200 for an operator to input commands into vehicle control system 100. In some examples, the input devices 200 may be one or more inceptors, such as a first inceptor 202 and a second inceptor 204. Some non-limiting examples of first inceptor 202 and/or second inceptor 204 may include side-sticks, joysticks, and/or yokes. In some embodiments, input devices 200 may include buttons, switches, microphones, joysticks, yokes, steering wheels, pedals, sensors, touchscreens, cameras, gesture recorders, any other suitable input device capable executing a command, and the like. Input devices 200 may be operatively coupled with flight controller 140 via suitable connection means. With reference to the depicted embodiments, input devices 200 may include a first inceptor 202, a second inceptor 204, a touch display screen 206, and/or foot pedals 203, which will be described further below.

As described above, FIG. 3 depicts an example cockpit 108 with a plurality of input devices 200. FIG. 3 shows first inceptor 202 to the left of seat 201 and second inceptor 204 right of seat 201. Although the arrangement of FIG. 3 may allow an operator to use first inceptor 202 and second inceptor 204 while resting the pilot's arms on seat 201, a number of different configurations are contemplated. For example, first inceptor 202 and/or second inceptor 204 may be located on a console in front of seat 201. In another example, both of first inceptor 202 and second inceptor 204 may be to the left or to the right of seat 201. First inceptor 202 and/or second inceptor 204 may be located on a cockpit surface such as a wall to the left or to the right of seat 201. In some embodiments, first inceptor 202 and/or second inceptor 204 may extend horizontally (instead of vertically) from the cockpit surface.

As discussed above, VTOL aircraft 102 may utilize a traditional flight control system and/or configuration. Such traditional flight control systems and/or configurations may utilize a dual inceptor operation. As shown in FIG. 3, input devices 200 may also utilize touch display systems, i.e., touch display screen 206, in the cockpit 108 for aircraft operations. From the operator seat 201, an operator may effectively operate and control both first inceptor 202 and second inceptor 204, as well as a third input device, such as any present touch display screen 206. The vehicle control system 100 may utilize any number of touch display screens as appropriate and necessary. In some examples, foot pedals 203 may be an additional input of the vehicle control system 100.

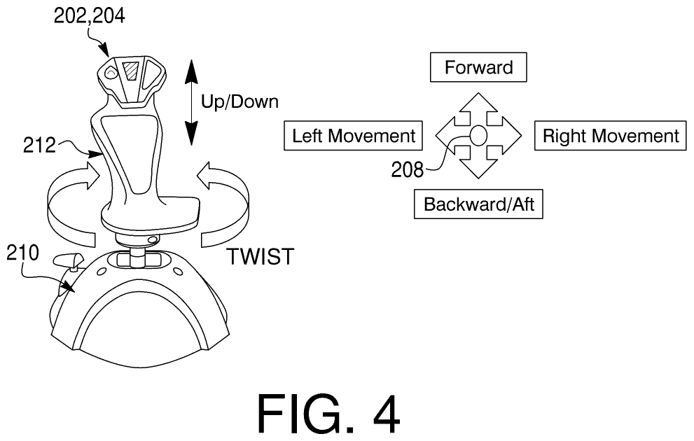

FIG. 4 shows an example inceptor (e.g., first inceptor 202; second inceptor 204) that may be incorporated in vehicle control system 100, as discussed above with respect to first inceptor 202 and second inceptor 204. FIG. 4 describes an example referring to first inceptor 202, however, the features and operation of first inceptor 202 may also be incorporated with respect to second inceptor 204, and/or any of input devices 200. First inceptor 202 may include a shaft 212. Shaft 212 may be placed, applied, formed, integrated, fastened, and/or otherwise attached onto a base 210. In some embodiments, shaft 212 may be attached to base 210 via an attachment means, which may be any appropriate means to couple shaft 212 to base 210, while still allowing movement of shaft 212 in various directions, e.g., forward, aft (i.e., toward the tail of an aircraft), right, and left. In some examples, shaft 212 may be moved relative to base 210 at angle. In other examples, shaft 212 may move at any direction about 360 degrees. The attachment means may also allow shaft 212 to, move up, down, and/or twist relative to base 210, e.g., twist in a left direction and/or twist in a right direction. For example, attachment means may be a screw, bolt, rivet, threaded rod, fastener, or any combinations thereof. In some examples, shaft 212 may be configured to be removably connected with base 210. Shaft 212 may have any appropriate size, shape, and/or configuration, such that the operator can ergonomically and/or effectively operate shaft 212 and its components.

First inceptor 202 may include additional components. For example, first inceptor 202 may include a spring-loaded actuator. A spring-loaded actuator may be located on or within an appropriate part of first inceptor 202, such that first inceptor 202 may return to initial position 208, e.g., a neutral, resting, or initial position after movement or manipulation of first inceptor 202. For example, after an operator shifts first inceptor 202 in a forward direction, a spring-loaded actuator may return first inceptor 202 to initial position 208. Once first inceptor 202 is in initial position 208, a minimal force may be applied to first inceptor 202 to move it in a desired direction. This minimal force may be referred to as a “break-out force.” In some other examples, first inceptor 202 may include an adjustable actuator that may change the “break out force” feel of the initial position 208. The adjustable actuator may be configured to provide a first tactile feel in a first mode of operation, and a second tactile feel in a second mode of operation. In another example, the tactile feel may change in real time to facilitate better control of VTOL aircraft 102 as conditions change. In this example, an electric actuator may replace or supplement the spring-loaded actuator.

In some embodiments, first inceptor 202 may include a signal or a variety of signals or indicators. For example, such signal(s) or indicator(s) could be a light or a variety lights that may turn on and off, and/or blink, to indicate designated messages to an operator. For example, signals may indicate first inceptor 202 is properly operating. In other examples, signals may indicate the different phases of flight, e.g., vertical takeoff and landing (VTOL), wingborne flight, transition phases, etc. Signals may also indicate the different directional inputs, e.g., twist (left and right rotational movements), push and pull inputs (up and down movements), longitudinal inputs (forward/backward movements) and lateral inputs (left/right movements). These directional inputs will be further discussed below.

An operator may selectively manipulate, interact, operate, or otherwise move shaft 212 of first inceptor 202. The inputs (e.g., directional), including, e.g., twist (left and right rotational movements), push and pull inputs (up and down movements), longitudinal inputs (forward/backward movements) and lateral inputs (left/right movements), may correspond to different movements of the vehicle (e.g., brought about by controlling the tilt rotors 130, rotors 132, and control surfaces 134). First inceptor 202 may include or otherwise be functionally coupled to flight controller 140 (schematically shown in FIG. 5). Flight controller 140 may be configured to receive the inputs and translate the movements into various controls, as will be discussed in detail below. Flight controller 140 utilizes first inceptor 202 for both VTOL configuration 150 and wingborne configuration 152, with the directional movements corresponding to specific commands in each configuration.

Operation of first inceptor 202 may be divided into two general phases of flight—vertical takeoff and landing (VTOL) phase operation (corresponding to VTOL configuration 150) and wingborne phase operation (corresponding to the wingborne configuration 152). Each phase of operation may maneuver VTOL aircraft 102 in different ways based on the configuration of VTOL aircraft 102 and one or more characteristics as determined by vehicle control system 100, which will be described further below. There may also be transitional phases, e.g., transitioning from VTOL phase operation to wingborne phase operation, and transitioning from wingborne phase operation to VTOL phase operation. For example, after vertical takeoff and as the vehicle increases in speed, vehicle control system 100 may be used to transition from VTOL configuration 150 and VTOL phase operation to the wingborne configuration 152 and wingborne phase operation. As the operator prepares to land, the vehicle slows down, and the vehicle control system 100 again may be used to transition from wingborne phase to VTOL phase, allowing the operator to position VTOL aircraft 102 for landing, e.g., over a vertiport or helipad. As VTOL aircraft 102 transitions between different speeds and configurations, different controls strategies may be mapped onto one or more of the input devices 200. For example, specific directional inputs mapped to designated axes of first inceptor 202 may be utilized in VTOL configuration 150 and wingborne configuration 152 to change direction, position, orientation, and/or speed of VTOL aircraft 102. In some examples, a first control method may be utilized for VTOL configuration 150 and a second control may be utilized for wingborne configuration 152 on each input device 200. In this example, when two inputs devices 200 are used, input device operation may reduce pilot workload by providing both longitudinal control and lateral control (e.g., planform control) on a single input device, and directional control and vertical control (e.g., flight path angle control) on a single input device.

Vehicle control system 100 may determine a control method based on the speed of VTOL aircraft 102. For example, in low-speeds, such as during takeoff and landing, vehicle control system 100 may function in a first mode and a second mode when VTOL aircraft 102 is traveling at relatively higher speeds, such as during wingborne flight. As VTOL aircraft 102 operates at a variety of speeds (e.g., low, medium, transitional, and/or high-speeds), an operator may operate one or more input devices 200 (e.g., first inceptor 202) between an initial state and a second state which is different than the initial state. A first control strategy including one or more commands may be mapped to the initial state, and a second control strategy including one or more commands may be mapped to the second state of input devices 200. In some examples, such as when using first inceptor 202, the initial state of the input device may be an in-detent control, and the second state of the input device may be an out-of-detent control. The initial state may correspond to initial position 208 when an inceptor is used (e.g., first inceptor 202). The second state may be a manipulation of an input device to change from the initial state. For example, when first inceptor 202 is used as the input device, initial position 208 may send a first command associated with the first state, and when first inceptor 202 is in a second position, such as one of the directional inputs described above, first inceptor 202 may send a second command associated with the second state. In other words, when first inceptor 202 is used as the input device, the inceptor may be in the second state when the inceptor is pushed, pulled, twisted, moved up, moved down, or a combination thereof away from initial position 208. In another example, when a touch display screen 206 is used as the input device, the initial state may be associated with a first action (e.g., touching, sliding, pointing) and the second state may be associated with a second action different than the first action (e.g., touching, sliding, pointing). In another example, when pedals 203 are used as the input device, moving pedals 203 between a first position and a second position, such as in or out, pedals 203 may send a command associated with the particular movement.

Input devices 200 may be used to control VTOL aircraft 102 with a first set of parameters corresponding to the initial state (e.g., in-detent control) and the second state (e.g., out-of-detent control) at a first speed range, described further below. Similarly, input devices 200 may be used to control VTOL aircraft 102 with a second set of parameters corresponding to the initial state (e.g., in-detent control) and the second state (e.g., out-of-detent control) at a second speed described further below. Additionally, in some examples, input devices 200 may be used to control VTOL aircraft 102 with a third set of parameters corresponding to the initial state (e.g., in-detent control) and the second state (e.g., the out-of-detent control) at a third speed range, described further below. In some examples, vehicle speed may refer to a sliding scale along which one or more commands of flight controller 140 may change. Each of the control strategies may be implemented on the same input device depending on the speed profile that VTOL aircraft 102 is traveling. The control strategies between each of the speed profiles mapped onto the input device may have commands to maneuver the aircraft in a relatively similar way to one another (e.g., longitudinal directional rate command at low-speed, and acceleration along the longitudinal axis at high-speed). By keeping similar commands mapped onto the same input device at different speeds, a pilot may have an easier and more intuitive experience controlling the VTOL aircraft 102.

Flight controller 140 may determine different commands based on whether an input device (e.g., first inceptor 202) is in the initial state or the second state. Although any suitable input device of input devices may be used, the following examples will focus on inceptor operation, particularly first inceptor 202. Although first inceptor 202 operation with control system 100 and flight controller 140 will be described further, other input devices and manipulations to change the state of the input devices between the initial state and the second state are contemplated. First inceptor 202 is in-detent when in initial position 208 (see FIG. 4). In-detent may refer to an inceptor state wherein the operator is not applying a force to first inceptor 202 and the operator is not resisting a spring force (e.g., the operator is not providing input or operator input is less than a “break out force” threshold where the threshold is based on an amount of force associated with operator intention). Out-of-detent may refer to an inceptor state in which the operator is actively applying a force to first inceptor 202 greater than the “break out” force and may feel feedback or a spring force exerted by first inceptor 202 on the operator's hand. An operator may switch between in-detent and out-of-detent by manipulating first inceptor 202 via one or more of the actions described further below, with reference to FIG. 4. Flight controller 140 may determine that if first inceptor 202 is in-detent or out-of-detent, and then send a command corresponding to the orientation of first inceptor 202.

FIG. 6 illustrates one example of the method utilized by flight controller 140 to control VTOL aircraft 102. The following description refers to first inceptor 202, however, the features and operation of first inceptor 202 may also be incorporated with respect to second inceptor 204, or any other suitable input device 200. Starting at step 316, flight controller 140 determines a speed profile base on the operating speed of VTOL aircraft 102 from input signals of at least one of input devices 200. For example, the speed profile may be a low-speed profile, a transition speed profile, or a high-speed profile. Next, flight controller 140 determines the position and/or orientation of first inceptor 202 by receiving input signals from first inceptor 202. Flight controller 140 will first determine whether first inceptor 202 is in initial position 208 (e.g., in-detent) or moved from initial position 208 (e.g., out-of-detent; change of orientation). When flight controller 140 determines that first inceptor 202 is out-of-detent, flight controller 140 determines which direction first inceptor 202 has been moved (e.g., front, back, up, down, left, right, twist), Based on the speed profile, and whether first inceptor 202 is at initial position 208, flight controller 140 will respond to the input signals from first inceptor 202 in different ways. For example, in step 320, first inceptor 202 is out-of-detent and flight controller 140 may execute a first command to perform a first action of VTOL aircraft 102 in one or more degrees of freedom. In another example, in step 322, first inceptor 202 is in-detent, and flight controller may execute a second command to perform a second action of VTOL aircraft 102 in one or more degrees of freedom. The command is dependent on the speed profile of VTOL aircraft 102, such that a first command in the first speed profile may be different than a first command in the second speed profile. In some examples, the first command of step 320 and the second command of step 322 may be different actions to maneuver VTOL aircraft 102. In some other examples, the first command of step 320 and the second command of step 322 may output the same action for VTOL aircraft to perform. Examples of the various speed profiles and the control commands by first inceptor 202 in-detent and out-of-detent is described further below.

Although the present example refers to a first command and a second command for illustrative purposes, it is contemplated that flight controller 140 may output any number of commands based on any number of inputs from input devices 200. For example, flight controller may send a first command, a second command, a third command, a fourth command, and/or even a plurality of commands. Each command may be associated with one or more of the speed profiles. Each command may include a directional component. In one example, a command associated with the second state of the input device may be a translational rate command that has a first direction component of first inceptor (e.g. forward, right, up, clockwise), and a second direction component of first inceptor 202 (e.g., backward, left, down, counterclockwise) corresponding to a maneuver of VTOL aircraft 102. Each of the commands may be a different command. One or more of the plurality of commands may be the same command. It is contemplated that any command may be an in-detent command, an out-of-detent command, or both.

As described above, flight controller 140 may send a first command and/or a second command to tilt rotors 130, rotors 132, and control surfaces 134 depending on the speed profile and state of the input device to maneuver VTOL aircraft 102. In some examples, the first command and/or the second command may be a command to control movement of VTOL aircraft 102 along and/or about vertical axis 110, longitudinal axis 112, lateral axis 114, or a combination thereof. In some examples, out-of-detent controls may correspond with directional movement of VTOL aircraft 102 in one or more degrees of freedom, and in-detent controls may correspond with holding a position, orientation, speed, or direction of VTOL aircraft 102 in one or more degrees of freedom, providing a safe and predictable hands-off response.

### Example Commands—Longitudinal

In some examples, an out-of-detent command may relate to controlling VTOL aircraft 102 relative to longitudinal axis 112. One example may be a longitudinal translational rate command (TRC). The longitudinal TRC may control tilt rotors 130, rotors 132, and/or control surfaces 134 to move VTOL aircraft 102 along longitudinal axis 112 when VTOL aircraft 102 is in VTOL configuration 150. Another example of controlling VTOL aircraft 102 relative to longitudinal axis 112 may be an acceleration command. An acceleration command may control tilt rotors 130, rotors 132, and/or control surfaces 134 to increase or decrease the velocity that VTOL aircraft 102 is traveling along longitudinal axis 112 when in wingborne configuration 152.

In some examples, an in-detent command may relate to controlling VTOL aircraft 102 relative to longitudinal axis 112. One example command may be a longitudinal position hold command. The longitudinal position hold command may control tilt rotors 130, rotors 132, and/or control surfaces 134 to limit or eliminate movement of VTOL aircraft 102 along longitudinal axis 112 when VTOL aircraft 102 is in VTOL configuration 150. In some examples, the longitudinal position hold command may automatically decelerate VTOL aircraft 102 along longitudinal axis 112 when the input device is returned to the initial state. Another example of controlling VTOL aircraft 102 along longitudinal axis 112 may be a speed hold command. A speed hold command may control tilt rotors 130, rotors 132, and/or control surfaces 134 to keep a constant velocity of VTOL aircraft 102 along longitudinal axis 112 when in wingborne configuration 152. In one example, a longitudinal speed hold command may maintain a speed which VTOL aircraft 102 that was commanded to by the out-of-detent acceleration command. In another example, a speed hold command may return VTOL aircraft 102 to a speed set by a user.

### Example Commands—Lateral

In some examples, an out-of-detent command may control VTOL aircraft 102 relative to lateral axis 114. One example may be a lateral TRC. The lateral TRC may control tilt rotors 130, rotors 132, and/or control surfaces 134 to move VTOL aircraft 102 along lateral axis 114 (e.g., side to side) when VTOL aircraft 102 is in VTOL configuration 150. The lateral TRC may be automated or selectable. Another example may be coordinating a roll attitude command. A roll attitude command may control a roll attitude of VTOL aircraft 102 by controlling tilt rotors 130, rotors 132, and/or control surfaces 134 to adjust an angle of lateral axis 114 of VTOL aircraft 102 relative to the horizon by rotating about longitudinal axis 112. Similarly, another example of an out-of-detent command may be a rate of turn command. The rate of turn command may correspond to a number of degrees of heading change over an amount of time that VTOL aircraft 102 adjusts by controlling tilt rotors 130, rotors 132, and/or control surfaces 134 in wingborne configuration 152. Another example of an out-of-detent command may be a sideslip command. The sideslip command may control tilt rotors 130, rotors 132, and/or control surfaces 134 to control the rate that VTOL aircraft 102 turns about vertical axis 110 (e.g., yaw) in wingborne configuration 152. For example, a sideslip command may adjust an angle of VTOL aircraft 102 about vertical axis 110 while VTOL aircraft is maintaining a high-speed in the longitudinal direction.

In some examples, an in-detent command may control VTOL aircraft 102 relative to lateral axis 114. One example may be a lateral position hold command. The lateral position hold command may control tilt rotors 130, rotors 132, and/or control surfaces 134 to limit or eliminate movement of VTOL aircraft 102 along lateral axis 114 (e.g., side to side) when VTOL aircraft 102 is in VTOL configuration 150. In some examples, the lateral position hold command may be automated or selectable. In some examples, the lateral position hold command may automatically decelerate VTOL aircraft 102 along lateral axis 114 when input device is returned to the initial state. Another example may be a lateral speed hold command. A lateral speed hold command may control tilt rotors 130, rotors 132, and/or control surfaces 134 to limit or eliminate a change in velocity along and/or about lateral axis 114 of VTOL aircraft 102. In one example, a lateral speed hold command may maintain a speed which VTOL aircraft 102 was commanded to by the out-of-detent acceleration command. In another example, a speed hold command may return VTOL aircraft 102 to a speed set by a user. In some examples, the lateral speed hold command may be applied when VTOL aircraft 102 is operating in at a transitional speed. In some examples, lateral speed hold command may be used at a transitional speed in either VTOL configuration 150 or wingborne configuration 152. Another example of controlling VTOL aircraft 102 relative to lateral axis 114 is a heading hold command. The heading hold command may control tilt rotors 130, rotors 132, and/or control surfaces 134 to limit or eliminate a change in the direction that the nose of VTOL aircraft 102 is pointing relative to North when in wingborne configuration 152. For example, heading hold command may hold the direction which VTOL aircraft 102 is pointing. Another example may be a course hold command. The course hold command may control tilt rotors 130, rotors 132, and/or control surfaces 134 to limit or eliminate a change in the path that VTOL aircraft 102 is traveling over the ground. For example, a course hold may maintain the direction which VTOL aircraft 102 is traveling over the ground (e.g., actual direction of motion; trajectory). Another example of controlling VTOL aircraft 102 relative to lateral axis 114 is a track hold command. The track hold command may control tilt rotors 130, rotors 132, and/or control surfaces 134 to limit or eliminate a change in the direction that VTOL aircraft 102 is actually flying when in wingborne configuration 152. In another example, a turn coordination command may be executed when the input device is in-detent. The turn coordination command may control tilt rotors 130, rotors 132, and/or control surfaces 134 to execute a turn of VTOL aircraft 102 in wingborne configuration 152. The turn coordination command may automatically execute a turn of VTOL aircraft 102.

### Example Commands—Directional

In some examples, an out-of-detent command may control VTOL aircraft 102 relative to vertical axis 110. One example may be a yaw TRC. The yaw TRC may control tilt rotors 130, rotors 132, and/or control surfaces 134 to move VTOL aircraft 102 about vertical axis 110 when VTOL aircraft 102 is in VTOL configuration 150. Another example of controlling VTOL aircraft 102 with respect to vertical axis 110 may be a sideslip command. The sideslip command may control tilt rotors 130, rotors 132, and/or control surfaces 134 to control an angle about vertical axis 110 (e.g., yaw) while VTOL aircraft 102 travels along longitudinal axis 112 at high-speed in wingborne configuration 152. Another example may be coordinating a roll attitude command. A roll attitude command may maneuver VTOL aircraft 102 by controlling tilt rotors 130, rotors 132, and/or control surfaces 134 to adjust an angle of lateral axis 114 of VTOL aircraft 102 relative to the horizon by rotating about longitudinal axis 112 (e.g., controlling a roll VTOL aircraft 102). Similarly, another example of an out-of-detent command may be a rate of turn command. The rate of turn command may correspond to a number of degrees of heading change over an amount of time that VTOL aircraft 102 adjusts by controlling tilt rotors 130, rotors 132, and/or control surfaces 134 in wingborne configuration 152. Another example of an out-of-detent command may be a sideslip command. The sideslip command may control tilt rotors 130, rotors 132, and/or control surfaces 134 to control the rate that VTOL aircraft 102 turns about vertical axis 110 (e.g., yaw) in wingborne configuration 152. For example, a sideslip command may adjust an angle of VTOL aircraft 102 about vertical axis 110 while VTOL aircraft is maintaining a high-speed in the longitudinal direction.

In some examples, an in-detent command may relate to controlling VTOL aircraft 102 relative to vertical axis 110. One example command may be a heading hold. In this example, the heading hold may control tilt rotors 130, rotors 132, and/or control surfaces 134 to limit or eliminate a change in the direction that the nose of VTOL aircraft 102 is pointing relative to North. The heading hold command may be applied in both VTOL configuration 150 and wingborne configuration 152, depending on the control strategy. Another example may be a course hold command. The course hold command may control tilt rotors 130, rotors 132, and/or control surfaces 134 to limit or eliminate a change in the path that VTOL aircraft 102 is traveling over the ground. For example, a course hold may maintain the direction which VTOL aircraft 102 is traveling over the ground (e.g., actual direction of motion; trajectory). Another example of controlling VTOL aircraft 102 relative to lateral axis 114 is a track hold command. The track hold command may control tilt rotors 130, rotors 132, and/or control surfaces 134 to limit or eliminate a change in the direction that VTOL aircraft 102 is actually flying when in wingborne configuration 152. In another example, a turn coordination command may be executed when the input device is in-detent. The turn coordination command may control tilt rotors 130, rotors 132, and/or control surfaces 134 to execute a turn of VTOL aircraft 102 in wingborne configuration 152. The turn coordination command may automatically execute a turn of VTOL aircraft 102.

### Example Commands—Vertical

In some examples, an out-of-detent command may control VTOL aircraft 102 with relative to vertical axis 110, such as a vertical speed command. The vertical speed command may control tilt rotors 130, rotors 132, and/or control surfaces 134 to move VTOL aircraft 102 at a commanded rate of speed along vertical axis 110 (e.g., up and down) when VTOL aircraft 102 is in VTOL configuration 150. Another example of controlling VTOL aircraft 102 with respect to vertical axis 110 may be a flight path angle command. The flight path angle command may control tilt rotors 130, rotors 132, and/or control surfaces 134 to control the angle (e.g., direction which the nose of the aircraft is pointing along vertical axis 110) of VTOL aircraft 102 when VTOL aircraft 102 is in wingborne configuration 152. Put another way, flight path angle may be an angle of pitch (positive or negative) which VTOL aircraft 102 is oriented at. Further, the vertical speed command may be a function of the ground speed (i.e., the horizontal speed of a vehicle relative to the Earth's surface) and the flight path angle

An in-dent command may relate to controlling VTOL aircraft 102 relative to vertical axis 110. One example of the in-detent commands relative to the vertical axis 110 may be a vertical speed hold command. The vertical speed hold command may control tilt rotors 130, rotors 132, and/or control surfaces 134 to limit or eliminate a change in velocity along vertical axis 110 of VTOL aircraft 102. In one example, the vertical speed hold command may maintain a speed which VTOL aircraft 102 that was commanded to by the out-of-detent vertical speed command. In another example, the vertical speed hold command may return VTOL aircraft 102 to a vertical speed set by a user. In another example of an in-detent command may be a height hold command. The height hold command may control tilt rotors 130, rotors 132, and/or control surfaces 134 to maintain a height of VTOL aircraft 102 in VTOL configuration 150. The height hold command may be automatic or selectable. The height hold command may maintain a height and/or return to a height selected by a user of VTOL aircraft 102. Another example may be an altitude hold command. The altitude hold command may control VTOL aircraft 102 at high-speeds in wingborne configuration 152. In one example, an altitude hold command may control tilt rotors 130, rotors 132, and/or control surfaces 134 to maintain an altitude of VTOL aircraft 102 in wingborne configuration 152. The altitude hold command may be automatic or selectable. The altitude hold command may maintain an altitude and/or return to an altitude selected by a user of VTOL aircraft 102. In another example, the in-detent command may be a flight path angle hold. The flight path angle hold command may control tilt rotors 130, rotors 132, and/or control surfaces 134 to limit or eliminate a change in the flight path angle. The flight path angle hold command may be applied when VTOL aircraft 102 is in wingborne configuration 152.

Referring again to FIG. 4, which depicts one example of an input device, shown here as first inceptor 202 with directional inputs. In some examples, a first command associated with a first speed profile may be mapped to the initial state of the input device and a second command associated with a first speed profile may be mapped to the second state of the input device. The same input device may then have a third command associated with a second speed profile mapped to the initial state of the input device, and a fourth command associated with a second speed profile mapped to the second state. In some examples, each pair of movements along an axis, such as front and back, left and right, up and down, clockwise and counterclockwise twist, may be associated with a command associated with the second state. In one example, when VTOL aircraft 102 is in VTOL configuration 150, first inceptor 202 may correspond forward movement of shaft 212 to longitudinal TRC in a forward direction, and correspond backward or aft movement of shaft 212 to longitudinal TRC in a backwards/aft direction. Left movement of shaft 212 may correspond to lateral TRC in a left direction. Right movement of shaft 212 may correspond to lateral TRC in a right direction. When shaft 212 returns to initial position 208, first inceptor 202 may command a position hold of VTOL aircraft 102. In another example, when VTOL aircraft 102 is in VTOL configuration 150, forward and backward movement of shaft 212 may correspond with a vertical speed command, and side-to-side movement of shaft 212 may correspond to a yaw rate command to change a heading of VTOL aircraft 102. Alternatively, in another example, shaft 212 may also be twisted in a right direction (e.g., in a clockwise direction) and/or in a left direction (e.g., in a counterclockwise direction) which may alter a heading, e.g., a yaw rate command, and/or a vertical rate command. In one example, when shaft 212 returns to initial position 208, first inceptor 202 may command a heading hold command, a vertical speed hold command, and/or a height hold command. In another example, shaft 212 may be pushed down towards base 210 or pulled up away from base 210. In some examples, pushing shaft 212 towards base 210 may correspond to a vertical TRC in a negative direction along vertical axis 110, and pulling shaft 212 away from base 210 may correspond to a vertical TRC in a positive direction along vertical axis 110. Any appropriate height reference may be used, e.g., baro, flight level, above ground level, etc.

With continued reference to FIG. 4, one example of the directional inputs of first inceptor 202 during wingborne configuration 152, forward and backward movement of shaft 212 may correspond to an acceleration command to adjust the speed which VTOL aircraft 102 is traveling. Left movement and right movement of shaft 212 may correspond to a roll attitude command and/or rate of turn command in the direction of the movement of shaft 212. In another example, left movement and right movement of shaft 212 may correspond to a sideslip command in the direction of the movement of shaft 212. In another example, clockwise and counterclockwise twisting of shaft 212 may correspond with a sideslip command, a roll attitude command, and/or a rate of turn command. In some examples, when shaft 212 is returned to initial position 208, inceptor 202 may command a speed hold. In another example, when shaft 212 is returned to initial position 208, inceptor 202 may command a heading hold command, course hold command, and/or track hold command. In another example, when shaft 212 is returned to initial position 208, inceptor 202 may command a turn coordination. As mentioned above, the turn coordination may be automatic. In another example, when VTOL aircraft 102 is in wingborne configuration 152, movement of shaft 212 forward and backward may correspond to flight path angle command. In some examples, when shaft 212 is returned to initial position 208, inceptor 202 may command a flight path angle hold. In another example, when shaft 212 is returned to initial position 208, inceptor 202 may command an altitude hold.

It is further contemplated that any of the directional inputs of inceptor 102 may be configured to control movement of VTOL aircraft 102 with any of the in-detent commands and the out-of-detent commands, as well as other commands that one of ordinary skill in the art would appreciate. Further, the directional inputs of inceptor 202 may be configured to provide a pilot with an intuitive relationship between manipulating the input device and aircraft response. Additionally, the control system 100 may be configured to minimize automated response-type switching, only changing when necessary to accommodate an inherent change in aircraft response due to flight regime or aircraft configuration change.

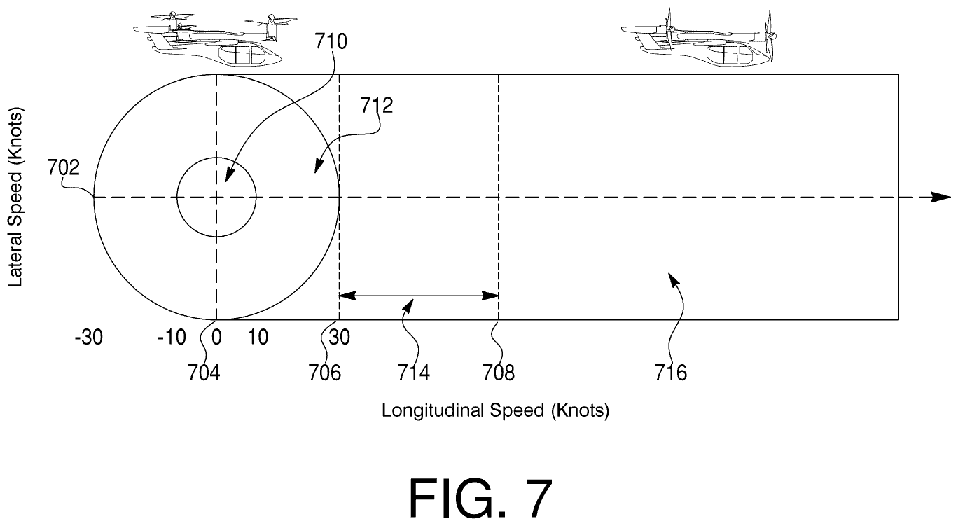

FIG. 7 is an exemplary diagram depicting example control envelopes that flight controller 140 may command in response to operation of inceptor 202 at different speeds. It will be appreciated that although speed is indicated in knots along an x-axis of the diagram of FIG. 7, any speeds may be used. The reflected speeds are not all-inclusive and merely illustrate and example. Parallel to the x-axis is longitudinal speed 702 corresponding to movement of VTOL aircraft 102 along longitudinal axis 112. The y-axis of graph FIG. 7 may reflect lateral speed 704 corresponding to the movement of VTOL aircraft 102 along lateral axis 114.

As the longitudinal speed of VTOL aircraft 102 increases, flight controller 140 may adjust the control responses. For example, low-speed control envelope 710 illustrates a boundary where commands may correspond to a low-speed speed profile that may be executed by flight controller 140 to maneuver VTOL aircraft 102 in VTOL configuration 150. Although shown as a circle in this example, low-speed control envelope 710 may have any suitable shape, such as an oval, semicircle, the like, or any other suitable boundary shape for controlling VTOL aircraft 102 at low speeds. Accordingly, when VTOL aircraft 102 is within low-speed control envelope 710, flight controller 140 may command tilt rotors 130, rotors 132, and control surfaces 134 to maneuver VTOL aircraft 102 in one or more degrees of freedom in VTOL configuration 150. During low-speed operation, VTOL aircraft 102 may hover and a user may use input devices 200 to use initial state commands and second state commands to maneuver and/or hold position of VTOL aircraft 102. Some example commands which flight controller 140 may command while VTOL aircraft 102 is in low-speed control envelope 710 corresponding to initial state commands (e.g. in-detent commands) may be longitudinal position hold command, lateral position hold command, heading hold command,, height hold command, or a combination thereof (described above). Some example commands which flight controller 140 may command while VTOL aircraft is in low-speed control envelop 710 corresponding to second state commands (e.g., out-of-detent commands) may be longitudinal TRC, lateral TRC, yaw rate command, vertical speed command, or a combination thereof. A skilled artisan will appreciate that other commands and control strategies may be implemented within low-speed control envelope 710.

As longitudinal speed 702 of VTOL aircraft 102 increases, VTOL aircraft 102 enters control envelope 712. Control envelope 712 is shown surrounding low-speed control envelope 710. In some examples, flight controller 140 may limit low-speed commands while VTOL aircraft 102 is in VTOL configuration 150 as VTOL aircraft 102 enters control envelope 712. In some examples, flight controller 140 may limit one or more commands, include one or more commands different commands than in low-speed control envelope 710, or both while VTOL aircraft is traveling above a threshold speed while in VTOL configuration 150. One example may be limiting lateral translation commands as VTOL aircraft 102 travels faster, however, other commands may also be limited or included. In control envelope 712, flight controller 140 may begin to implement low-speed turn coordination. As VTOL aircraft 102 travels within control envelope 712, flight controller 140 may command initial state commands (e.g., in-detent commands) may be a speed hold command, a heading hold command, an altitude hold command, or a combination thereof. As VTOL aircraft 102 travels within control envelope 712, flight controller 140 may command second state commands (e.g., out-of-detent commands) such as a longitudinal acceleration command, a lateral acceleration command, a yaw rate command, a vertical speed command, or a combination thereof.

Continually increasing longitudinal speed 702, VTOL aircraft 102 enters control envelope 714, between lower boundary speed 706 and upper boundary speed 708. Lower boundary speed 706 is shown in this example as 30 knots, however, any speed may be used to indicate lower boundary speed 706. Upper boundary speed 708 of control envelope 714 is approximately 30 Knots, however, any speed may be used to indicate upper boundary speed 708. In control envelope 714, flight controller 140 may transition from low-speed control logic to medium and high-speed control logics. When VTOL aircraft 102 is traveling at speeds within control envelope 714, VTOL aircraft may transition between VTOL configuration 150 and wingborne configuration 152, and vice versa. Flight controller 140 may command tilt rotors 130, rotors 132, and control surfaces 134 to maneuver VTOL aircraft 102 in VTOL configuration 150, wingborne configuration 152, or a combination of both as VTOL aircraft 102 is within control envelope 714.

Once VTOL aircraft 102 is moving at longitudinal speed 702 greater than the upper boundary speed 708 of control envelope 714, VTOL aircraft 102 may be in high-speed control envelope 716. In high-speed control envelope 716, flight controller 140 may send commands relating to high-speed control logic to tilt rotors 130, rotors 132, and control surfaces 134 to maneuver VTOL aircraft 102 in wingborne configuration 152. In high-speed control envelope 716, flight controller 140 uses automatic turn coordination. When VTOL aircraft 102 is traveling at a speed within high-speed control envelope 716, flight controller 140 may send control commands to maneuver VTOL aircraft 102 in one or more degrees of freedom. Some example control commands which are changed between control envelope 712 and high-speed envelope 716. Example changes between control envelope 712 and high-speed envelope 716 may be lateral acceleration command transitioning to roll attitude command and rate of turn command; speed hold command transitioning to course hold command, heading hold command, and/or track hold command; yaw rate command transitioning to sideslip command; heading hold command may transition to turn coordination; and vertical speed hold transitioning to flight path angle command.

FIG. 7 illustrates one example of the response types/command outputs in the aircraft axis system and not inceptor conventions. As mentioned above, the tilt rotors 130, rotors 132, and control surfaces 134 are automatically controlled by vehicle control system 100 without operator intervention. FIG. 7 illustrates example low-speed control envelope 710, control envelope 714, and high-speed control envelope 716 in one example shape with one example scale, however, any shape or scale may be used with reference to low-speed control envelope 710, transitional control envelope 714, and high-speed control envelope 716. The response thresholds illustrated are one example, however, other examples and methods are contemplated.

### Example Control Strategies

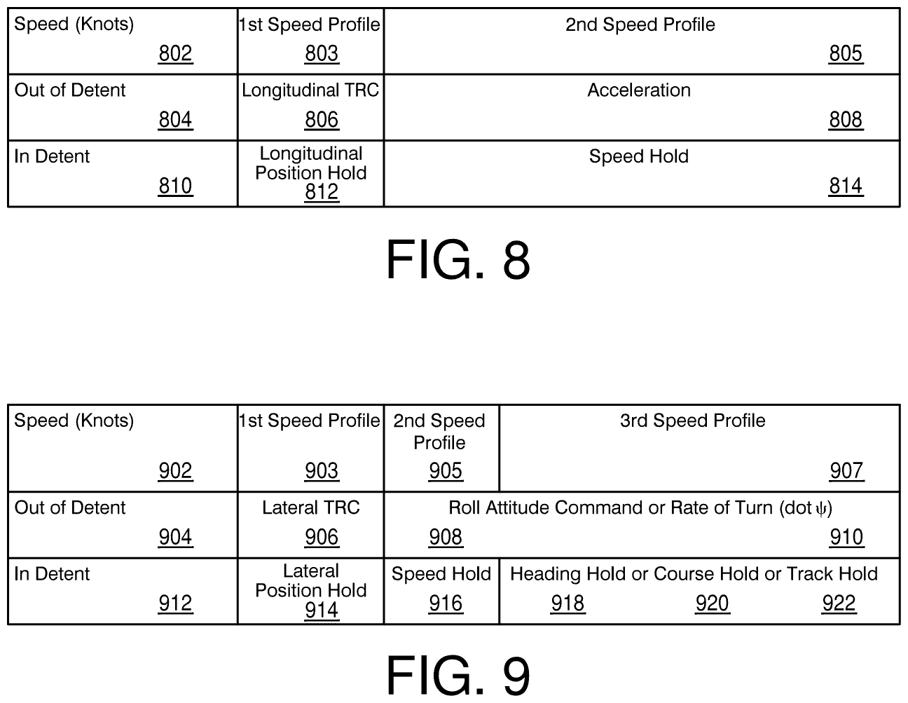

FIGS. 8-14 are exemplary diagrams depicting attitude focused and/or flight path focused example control strategies with a plurality of commands flight controller 140 may issue in response to input device operation, relating to controlling movement of VTOL aircraft 102. In some examples, attitude-focused generally describes the orientation of VTOL aircraft 102 relative to itself, whereas the flight path focused refers to the orientation of VTOL aircraft 102 relative to the world around the aircraft. In some examples, tilt rotors 130, rotors 132, and control surfaces 134 of VTOL aircraft 102 may be managed automatically vehicle control system 100 without operator interference. In other examples, tilt rotors 130, rotors 132, and control surfaces 134 of VTOL aircraft 102 may be partially or fully controlled by a pilot.

In some examples, such as shown in FIG. 8, flight controller 140 determines vehicle speed 802 and controls VTOL aircraft 102 based on a first speed profile 803 and a second speed profile 805. In this example, flight controller 140 may control movement of VTOL aircraft 102 along longitudinal axis 112. In this example, first speed profile 803 corresponds to low-speed, and second speed profile 805 corresponds to high-speed. As discussed with reference to FIG. 6, flight controller 140 determines the speed profile in step 316 and then the position and/or orientation of first inceptor 202 in step 318. Flight controller 140 at step 320 may issue a first command at step 320 when VTOL aircraft 102 is in the first speed profile 803 and first inceptor 202 is out-of-detent 804. In this example, the first command may be longitudinal TRC 806. Longitudinal TRC 806 may be a rate of translation along longitudinal axis 112 when VTOL aircraft 102 is in VTOL configuration 150. Flight controller 140 at step 320 may issue a first command at step 320 when VTOL aircraft 102 is in the second speed profile 805 and first inceptor 202 is out-of-detent 804 corresponding to an acceleration command 808 to control a rate of acceleration along longitudinal axis 112 when in VTOL aircraft is in wingborne configuration 152.

With continued reference to FIG. 8, when flight controller 140 determines that VTOL aircraft 102 is in first speed profile 803 at step 316 and first inceptor 202 is in-detent 810 at step 318, flight controller 140 may issue a second command at step 322 corresponding to a position hold command 812 of VTOL aircraft 102. Position hold command 812 may refer to limiting or eliminating movement along longitudinal axis 112 when VTOL aircraft 102 is in VTOL configuration 150. When flight controller 140 determines that VTOL aircraft 102 is in second speed profile 805 at step 316 and first inceptor 202 is in-detent 810 at step 318, flight controller 140 may issue a second command at step 322 corresponding to a longitudinal speed hold 814 of VTOL aircraft 102 in wingborne configuration 152.

FIG. 9 is an example diagrams depicting attitude-focused commands flight controller 140 may issue in response to inceptor operation, specifically along lateral axis 114. In some examples, such as shown in FIG. 9, flight controller 140 determines vehicle speed 902 and controls VTOL aircraft 102 based on a first speed profile 903, a second speed profile 905, and a third speed profile 907. In this example, flight controller 140 may control movement along lateral axis 114. In this example, the speed profiles are first speed profile 903 corresponding to low-speed, second speed profile 905 corresponding with transitional or intermediate speed, and third speed profile 907 corresponding with high-speed. As discussed with reference to FIG. 6, flight controller 140 determines the speed profile in step 316 and then the position and/or orientation of first inceptor 202 in step 318. When VTOL aircraft 102 is in first speed profile 903 and first inceptor 202 is out-of-detent 904, flight controller 140 may issue a first command (step 320). The first command may be lateral TRC 906 that may control tilt rotors 130, rotors 132, and control surfaces 134 to move VTOL aircraft 102 along lateral axis 114 when in VTOL configuration 150. When VTOL aircraft 102 is in second speed profile 905 and/or third speed profile 907, and first inceptor 202 is out-of-detent, the first command may be roll attitude command 908 (which may be used for a coordinated banked turn) or rate of turn command 910 for maneuvering VTOL aircraft 102 in the wingborne configuration 152.

With continued reference to FIG. 9, when flight controller 140 determines that VTOL aircraft 102 is in first speed profile 903 at step 316 and first inceptor 202 is in-detent 912 at step 318, flight controller 140 may issue a second command corresponding to lateral position hold command 914. When flight controller 140 determines that VTOL aircraft 102 is in second speed profile 905 at step 316 and first inceptor 202 is in-detent 912 at step 318, flight controller 140 may issue a second command corresponding to lateral speed hold command 916. Lateral speed hold command 916 may be applied in either VTOL configuration 150 or the wingborne configuration 152. When flight controller 140 determines that VTOL aircraft 102 is in third speed profile 907 at step 316 and first inceptor 202 is in-detent 912 at step 318, flight controller 140 may issue a third command. The third command may correspond to heading hold command 918, course hold command 920, and/or track hold command 922 when VTOL aircraft 102 is in wingborne configuration 152.

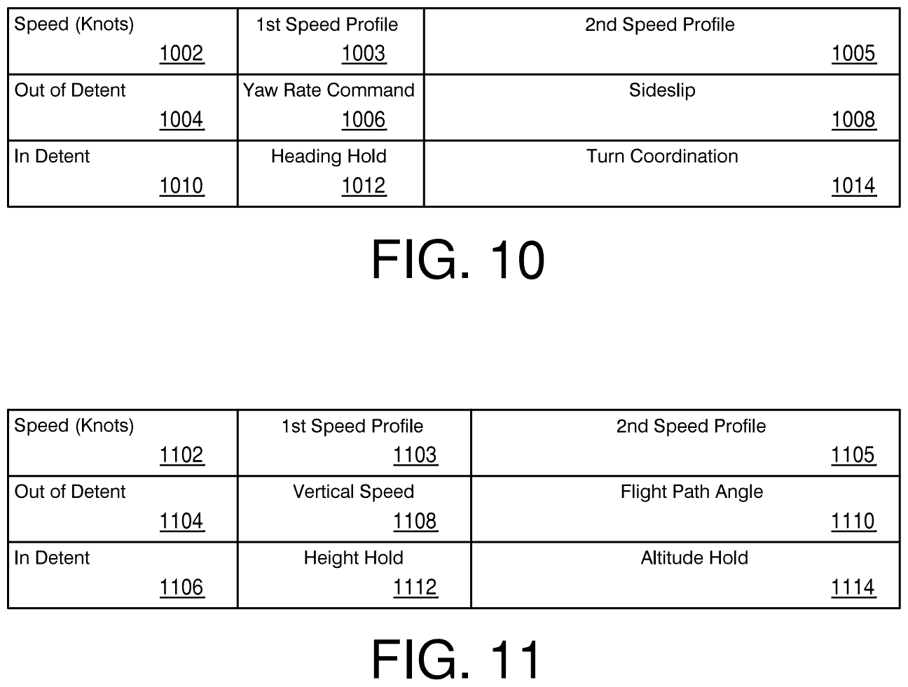

In some examples, such as shown in FIG. 10, flight controller 140 determines vehicle speed 1002 and controls VTOL aircraft 102 based on first speed profile 1003 and second speed profile 1005. In this example, flight controller 140 may control movement along vertical axis 110. In this example, first speed profile 1003 corresponds to low-speed, and second speed profile 1005 corresponds to high-speed. As discussed with reference to FIG. 6, flight controller 140 determines the speed profile in step 316 and then the position and/or orientation of first inceptor 202 in step 318. When VTOL aircraft 102 is in first speed profile 1003 and first inceptor 202 is out-of-detent 1004, flight controller 140 at step 320 may issue a first command corresponding to yaw TRC 1006 to control rotation of VTOL aircraft 102 about vertical axis 110 in VTOL configuration 150. When VTOL aircraft 102 is in second speed profile 1005 and first inceptor 202 is out-of-detent 1004, flight controller 140 at step 320 may issue a first command corresponding to sideslip command 1008 controlling a rate of change about vertical axis 110 when in the wingborne configuration 152.

With continued reference to FIG. 10, when flight controller 140 determines that VTOL aircraft 102 is in first speed profile 1003 at step 316 and first inceptor 202 is in-detent 1010 at step 318, flight controller 140 may issue a second command corresponding to vertical heading hold command 1012, limiting or eliminating movement in vertical axis 110 when in VTOL configuration 150. When flight controller 140 determines that VTOL aircraft 102 is in second speed profile 1005 at step 316 and first inceptor 202 is in-detent 1010 at step 318, flight controller 140 may issue a second command corresponding to a turn coordination command 1014, limiting slip and/or skid when in wingborne configuration 152.

In some examples, such as shown in FIG. 11, flight controller 140 determines vehicle speed 1102 and controls VTOL aircraft 102 based on first speed profile 1103 and second speed profile 1105. In this example, flight controller 140 may control movement along at least vertical axis 110. In this example, first speed profile 1103 corresponds to low-speed, and second speed profile 1105 corresponds to high-speed. As discussed with reference to FIG. 6, flight controller 140 determines the speed profile in step 316 and then the position and/or orientation of first inceptor 202 in step 318. When VTOL aircraft 102 is in first speed profile 1103 and first inceptor 202 is out-of-detent 1104, flight controller 140 at step 320 may issue a first command corresponding to vertical speed command 1108, controlling a vertical speed of VTOL aircraft 102 along vertical axis 110 when in VTOL configuration 150. When VTOL aircraft 102 is in second speed profile 1105 and first inceptor 202 is out-of-detent 1104, flight controller 140 at step 320 may issue a first command corresponding to flight path angle command 1110 to control an angle of VTOL aircraft 102 relative to the horizon along vertical axis 110 when in the wingborne configuration 152.

With continued reference to FIG. 11, when flight controller 140 determines that VTOL aircraft 102 is in first speed profile 1103 at step 316 and first inceptor 202 is in-detent 1106 at step 318, flight controller 140 at step 322 may issue a second command corresponding to height hold command 1112 to maintain VTOL aircraft 102 at a determined height relative to the ground in VTOL configuration 150. Similarly, when flight controller 140 determines that VTOL aircraft 102 is in second speed profile 1105 at step 316 and first inceptor 202 is in-detent 1106 at step 318, flight controller 140 at step 322 may issue a second command corresponding to altitude hold 1114 in wingborne configuration 152.

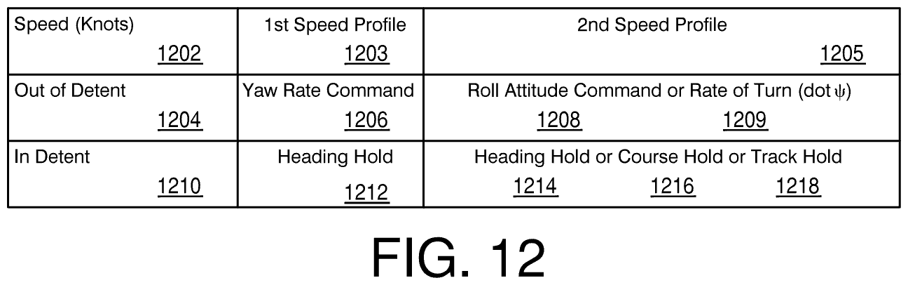

FIG. 12 is an example diagram depicting flight path commands flight controller 140 may issue in response to inceptor operation, specifically along vertical axis 110. In some examples, such as shown in FIG. 12, flight controller 140 determines vehicle speed 1202 and controls VTOL aircraft 102 based on first speed profile 1203 corresponding to low-speed, and second speed profile 1205 corresponding to high-speed. As discussed with reference to FIG. 6, flight controller 140 determines the speed profile in step 316 and then the position and/or orientation of first inceptor 202 in step 318. When VTOL aircraft 102 is in first speed profile 1203 and first inceptor 202 is out-of-detent 1204, flight controller 140 may issue a first command at step 320 corresponding to yaw TRC 1206 to control the rotation rate of VTOL aircraft 102 about vertical axis 110 in VTOL configuration 150. When VTOL aircraft 102 is in second speed profile 1205 and first inceptor 202 is moved out-of-detent 1204, flight controller 140 may issue a first command at 320 corresponding to roll attitude command 1208 (which may be used for a coordinated banked turn) or rate of turn command 1209 for maneuvering VTOL aircraft 102 in the wingborne configuration 152.

With continued reference to FIG. 12, when flight controller 140 determines that VTOL aircraft 102 is in first speed profile 1203 at step 316 and first inceptor 202 is in-detent 1210 at step 318, flight controller 140 may issue a second command at step 322 corresponding to heading hold command 1212 when VTOL aircraft 102 is in VTOL configuration 150. When flight controller 140 determines that VTOL aircraft 102 is in second speed profile 1205 at step 316 and first inceptor 202 is in-detent 1210 at step 318, flight controller 140 may issue a second command at step 322 corresponding to heading hold command 1214, course hold command 1216, and/or track hold command 1218 in the wingborne configuration 152.

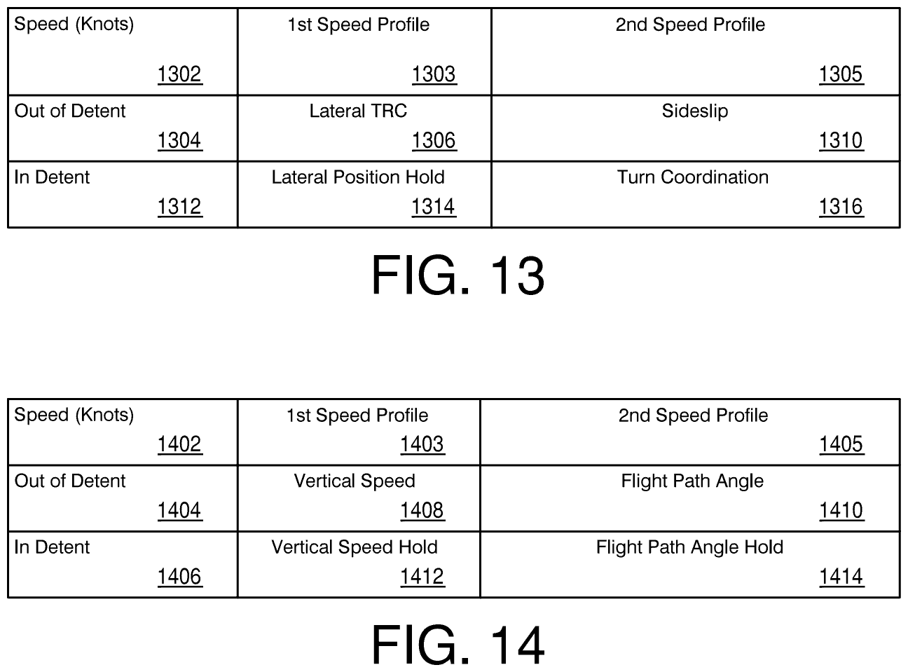

FIG. 13 is an example diagrams depicting flight path-focused commands flight controller 140 may issue in response to inceptor operation, specifically relative to lateral axis 114. In some examples, such as shown in FIG. 13, flight controller 140 determines vehicle speed 1302 and controls VTOL aircraft 102 based on first speed profile 1303, and second speed profile 1305. In this example, first speed profile 1303 corresponds to low-speed, and second speed profile 1305 corresponds with high-speed. As discussed with reference to FIG. 6, flight controller 140 determines the speed profile in step 316 and then the position and/or orientation of first inceptor 202 in step 318. When VTOL aircraft 102 is in first speed profile 1303 and first inceptor 202 is out-of-detent 1304, flight controller 140 may issue a first command at step 320 corresponding to lateral TRC 1306 in VTOL configuration 150. When VTOL aircraft 102 is in second speed profile 1405, and first inceptor 202 is out-of-detent 1304, flight controller 140 may issue sideslip command 1310 for maneuvering VTOL aircraft 102 when in wingborne configuration 152.

With continued reference to FIG. 13, when flight controller 140 determines VTOL aircraft 102 is in first speed profile 1303, and first inceptor 202 is in-detent 1312, flight controller 140 may provide a second command corresponding to lateral position hold command 1314 in VTOL configuration 150. When flight controller 140 determines that VTOL aircraft 102 is in second speed profile 1305 and first inceptor 202 is in-dent 1312, flight controller 140 may provide a second command corresponding to turn coordination command 1316 in wingborne configuration 152.

In some examples, such as shown in FIG. 14, flight controller 140 determines the vehicle speed 1402 and controls VTOL aircraft 102 based on first speed profile 1403 corresponding to a low-speed, and second speed profile 1405 corresponding to high-speed. In this example, flight controller 140 may control movement along vertical axis 110. As discussed with reference to FIG. 6, flight controller 140 determines the speed profile in step 316 and then the position and/or orientation of first inceptor 202 in step 318. When VTOL aircraft 102 is in first speed profile 1403 and first inceptor 202 is out-of-detent 1404, flight controller 140 may provide a first command at step 320 corresponding to vertical speed command 1408. Vertical speed command 1408 may increase or decrease the velocity of VTOL aircraft 102 along vertical axis 110 in VTOL configuration 150. When VTOL aircraft 102 is in second speed profile 1405 and first inceptor 202 is moved out-of-detent 1404, flight controller 140 may provide a first command at step 320 corresponding to flight path angle command 1410. Flight path angle command 1410 may command an angle of VTOL aircraft 102 relative to the ground and/or horizon when in wingborne configuration 152.

With continued reference to FIG. 14, when flight controller 140 determines that VTOL aircraft 102 is in first speed profile 1403 at step 316 and that first inceptor 202 is in-detent 1406 at step 318, flight controller 140 may issue a second command at step 322 corresponding to vertical speed hold 1412 while VTOL aircraft 102 is in VTOL configuration 150. Similarly, when flight controller 140 determines that VTOL aircraft 102 is in second speed profile 1405 at step 316 and that first inceptor 202 is in-detent 1406 at step 318, flight controller 140 may issue a second command corresponding to flight path angle hold 1414 while VTOL aircraft 102 is in wingborne configuration 152.

Aspects of the system may be formed of any suitable material with sufficient weight and components to withstand energy and impact from air flight and/or with any characteristics suitable for use in an aircraft. For example, vehicle control system 100 and any of its components thereof may include plastic materials, metals, metallic materials, polymers, composite materials, or combinations thereof.

Throughout this disclosure, references to components generally refer to items that logically can be grouped together to perform a function or group of related functions. Components and modules may be implemented in software, hardware or a combination of software and hardware. The tools, modules, and functions described above, including the controller, may be performed by one or more processors.

The description above and examples are illustrative and are not intended to be restrictive. One of ordinary skill in the art may make numerous modifications and/or changes without departing from the general scope of the disclosure. For example, and as has been referenced, aspects of above-described embodiments may be used in any suitable combination with each other. Additionally, portions of the above-described embodiments may be removed without departing from the scope of the disclosure. In addition, modifications may be made to adapt a particular situation or aspect to the teachings of the various embodiments without departing from their scope. Many other embodiments will also be apparent to those of skill in the art upon reviewing the above description.

The present disclosure is further described by the following non-limiting items:

Item 1. An aircraft control system for controlling an aircraft at a first speed and a second speed comprising: an input device configured to be manipulated by a user, the input device having a first orientation and a second orientation; at least one rotor operably coupled to a body of the aircraft; at least one control surface operably coupled to the body of the aircraft; and a controller coupled with the input device, the at least one rotor, and the at least one control surface, wherein the controller is configured to: determine a speed profile of the aircraft based on a speed which the aircraft is traveling; determine whether the input device is in the first orientation or the second orientation; send a command to one or both of the at least one rotor and the at least one control surface based at least in part on the speed profile and the orientation of the input device; and adjust at least one of the at least one rotor or the at least one control surface.

Item 2. The aircraft control system of Item 1, wherein, when the aircraft is in the speed profile corresponding to a first speed and the input device is in the first orientation, a first command is sent to the at least one rotor and/or the at least one control surface.

Item 3. The aircraft control system of Item 2, wherein, when the aircraft is in the speed profile corresponding to a second speed and the input device is in the first orientation, a second command is sent to the at least one rotor and/or the at least one control surface.

Item 4. The aircraft control system of Item 3, wherein, when the aircraft is in the speed profile corresponding to the first speed and the input device is in the second orientation, a third command is sent to the at least one rotor and/or the at least one control surface.

Item 5. The aircraft control system of Item 4, wherein, when the aircraft is in the speed profile corresponding to the second speed and the input device is in the second orientation, a fourth command is sent to the at least one rotor and/or the at least one control surface.

Item 6. The aircraft control system of Item 5, wherein each of the first command, the second command, the third command, and the fourth command are different from each other.

Item 7. The aircraft control system of Item 5, wherein the first command and the second command are the same, and the third command and the fourth command are different from the first command and the second command.

Item 8. The aircraft control system of Item 7, wherein the third command and the fourth command are different from one another.

Item 9. The aircraft control system of Item 5, further comprising a speed profile corresponding to a third speed; and wherein, when the input device is in the first orientation and the controller has determined that the aircraft is in the speed profile corresponding to the third speed, a fifth command is sent to the at least one rotor and/or at least one control surface.

Item 10. The aircraft control system of Item 1, wherein the input device is two input devices.

Item 11. The aircraft control system of Item 10, wherein the controller is further configured to: determine the orientation of the first input device; determine the orientation of the second input device; and send a command to the at least one rotor and/or the at least one control surface based on the speed profile and the orientation of the first input device and the orientation of the second input device.

Item 12. The aircraft control system of Item 10, wherein the two input devices are a first inceptor and a second inceptor.

Item 13. The aircraft control system of Item 1, wherein the second orientation of the input device is different from the first orientation of the input device.

Item 14. An aircraft control system, comprising: a first input device and a second input device, wherein each of the first input device and the second input device is configured to be manipulated by a user, the first input device and the second input device each having a first orientation and a second orientation different from the first orientation; at least one rotor operatively connected with a body of the aircraft; at least one control surface operatively connected to the body of the aircraft; a controller electrically coupled with the first input device, the second input device, the at least one rotor, and the at least one control surface, wherein the controller is configured to: determine a speed profile of the aircraft based on a speed of the aircraft; determine an orientation of the first input device; determine an orientation of the second input device; send a command to the at least one rotor and/or the at least one control surface based on the speed profile and the orientation of the first input device and the orientation of the second input device; and adjust the at least one rotor and/or the at least one control surface.

Item 15. The aircraft control system of Item 14, wherein the first input device is a first inceptor and the second input device is a second inceptor.

Item 16. The aircraft control system of Item 14, wherein, when the aircraft is in a first speed profile, the first input device is in the first orientation and the second input device is in the first orientation, a first command is sent to the at least one rotor and/or the at least one control surface.

Item 17. The aircraft control system of Item 16, wherein the first command is a compound movement causing the at least one rotor and/or the at least one control surface to change a position and an orientation of the aircraft.

Item 18. The aircraft control system of Item 16, wherein, when the aircraft is in the first speed profile, the first input device is in the first orientation and the second input device is in the second orientation, a second command is sent to the at least one rotor and/or the at least one control surface.

Item 19. The aircraft control system of Item 18, wherein, when the aircraft is in a second speed profile, the first input device is in the first orientation, and the second input device is in the second orientation, a third command is sent to the at least one rotor and/or the at least one control surface.

Item 20. The aircraft control system of Item 19, further comprising a third speed profile; and wherein, when the input device is in the first orientation and the controller has determined that the aircraft is in the third speed profile, a fourth command is sent to the at least one rotor and/or the at least one control surface.

Item 21. The aircraft control system of Item 14, wherein the first input device provides planform control of the aircraft and the second input device provides flight path angle control of the aircraft.

Item 22. A method of controlling an aircraft, the method comprising: determining a speed profile of the aircraft based on a speed which the aircraft is traveling, the speed profile corresponding to one or more of a high-speed, a transitional speed, and a low-speed; determining an orientation of an input device; and sending a command to at least one rotor and/or at least one control surface based on the speed profile and the orientation of the input device; and adjusting the at least one rotor and the at least one control surface.

What is claimed is:

1. An aircraft control system for controlling an aircraft at a first speed and a second speed comprising:
an input device configured to be manipulated by a user, the input device having a first orientation and a second orientation;
at least one rotor operably coupled to a body of the aircraft;
at least one control surface operably coupled to the body of the aircraft; and
a controller coupled with the input device, the at least one rotor, and the at least one control surface, wherein the controller is configured to:
determine a speed profile of the aircraft based on a speed which the aircraft is traveling;
determine whether the input device is in the first orientation or the second orientation;
send a command to one or both of the at least one rotor and the at least one control surface based at least in part on the speed profile and the orientation of the input device; and
adjust at least one of the at least one rotor or the at least one control surface.

2. The aircraft control system of claim 1, wherein, when the aircraft is in the speed profile corresponding to a first speed and the input device is in the first orientation, a first command is sent to the at least one rotor and/or the at least one control surface.

3. The aircraft control system of claim 2, wherein, when the aircraft is in the speed profile corresponding to a second speed and the input device is in the first orientation, a second command is sent to the at least one rotor and/or the at least one control surface.

4. The aircraft control system of claim 3, wherein, when the aircraft is in the speed profile corresponding to the first speed and the input device is in the second orientation, a third command is sent to the at least one rotor and/or the at least one control surface.

5. The aircraft control system of claim 4, wherein, when the aircraft is in the speed profile corresponding to the second speed and the input device is in the second orientation, a fourth command is sent to the at least one rotor and/or the at least one control surface.

6. The aircraft control system of claim 5, wherein each of the first command, the second command, the third command, and the fourth command are different from each other.

7. The aircraft control system of claim 5, wherein the first command and the second command are the same, and the third command and the fourth command are different from the first command and the second command.

8. The aircraft control system of claim 7, wherein the third command and the fourth command are different from one another.

9. The aircraft control system of claim 5, further comprising a speed profile corresponding to a third speed; and
wherein, when the input device is in the first orientation and the controller has determined that the aircraft is in the speed profile corresponding to the third speed, a fifth command is sent to the at least one rotor and/or at least one control surface.

10. The aircraft control system of claim 1, wherein the input device is two input devices.

11. The aircraft control system of claim 10, wherein the controller is further configured to:
determine the orientation of the first input device;
determine the orientation of the second input device; and
send a command to the at least one rotor and/or the at least one control surface based on the speed profile and the orientation of the first input device and the orientation of the second input device.

12. The aircraft control system of claim 10, wherein the two input devices are a first inceptor and a second inceptor.

13. The aircraft control system of claim 1, wherein the second orientation of the input device is different from the first orientation of the input device.

14. An aircraft control system, comprising:
a first input device and a second input device, wherein each of the first input device and the second input device is configured to be manipulated by a user, the first input device and the second input device each having a first orientation and a second orientation different from the first orientation;
at least one rotor operatively connected with a body of an aircraft;
at least one control surface operatively connected to the body of the aircraft;
a controller electrically coupled with the first input device, the second input device, the at least one rotor, and the at least one control surface, wherein the controller is configured to:
determine a speed profile of the aircraft based on a speed of the aircraft;
determine an orientation of the first input device;
determine an orientation of the second input device;
send a command to the at least one rotor and/or the at least one control surface based on the speed profile and the orientation of the first input device and the orientation of the second input device; and
adjust the at least one rotor and/or the at least one control surface.

15. The aircraft control system of claim 14, wherein the first input device is a first inceptor and the second input device is a second inceptor.

16. The aircraft control system of claim 14, wherein, when the aircraft is in a first speed profile, the first input device is in the first orientation and the second input device is in the first orientation, a first command is sent to the at least one rotor and/or the at least one control surface.

17. The aircraft control system of claim 16, wherein, when the aircraft is in the first speed profile, the first input device is in the first orientation and the second input device is in the second orientation, a second command is sent to the at least one rotor and/or the at least one control surface.

18. The aircraft control system of claim 17, wherein, when the aircraft is in a second speed profile, the first input device is in the first orientation, and the second input device is in the second orientation, a third command is sent to the at least one rotor and/or the at least one control surface.

19. The aircraft control system of claim 18, further comprising a third speed profile; and
wherein, when the input device is in the first orientation and the controller has determined that the aircraft is in the third speed profile, a fourth command is sent to the at least one rotor and/or the at least one control surface.

20. The aircraft control system of claim 14, wherein the first input device provides planform control of the aircraft and the second input device provides flight path angle control of the aircraft.
